(19) United States
(12) Patent Application Publication
(10) Pub. No.: US 2005/0053417 A1
(43) Pub. Date: Mar. 10, 2005

(54) Overlay binder

(76) Inventors: Norman Yamamoto, Yorba Linda, CA (US); Steven K. Piorek, Los Angeles, CA (US); Robert C. Tennant, West Hollywood, CA (US); Stuart A. Karten, Venice, CA (US)

Correspondence Address: FULWIDER PATTON LEE & UTECHT, LLP;HOWARD HUGHES CENTER, 6060 CENTER DRIVE, TENTH FLOOR, LOS ANGELES, CA, 90045, US

(21) Appl. No.: 10/829,342

(22) Filed: Apr. 20, 2004

Related U.S. Application Data
(60) Provisional application No. 60/464,591, filed on Apr. 21, 2003.

(51) Int. Cl. B42F 13/00

(52) U.S. Cl. 402/73

(57) ABSTRACT

Binders disclosed herein include a front cover, a back cover and a spine interconnecting the front cover and the back cover. The front cover includes a substantially transparent window integral with a first side of the front cover and an inner panel coupled to a second side of the front cover to form a pocket. Visual materials may be inserted into the pocket and be visible through the substantially transparent window.

### BACKGROUND

Papers and other media have been stored in portfolios, folders, binders, wire-bound notebooks, and the like. Binders, in particular, are a popular choice of storing media due to their ease of use, storage flexibility, and cost effectiveness. Binders are also desirable because papers or other media may be easily inserted and removed from the binders. Given the broad applications for binders, a wide variety of binders have been developed. For example, some prior art binders include a transparent cover so that visual materials may be visible from the front cover of the binder. Generally, a transparent sheet of flexible material is secured along three sides onto the cover of a binder to form a pocket into which visual presentation sheets may be inserted. However, such arrangements may be somewhat unfinished or unprofessional in their appearance.

### BRIEF SUMMARY

Exemplary embodiments disclosed herein are directed to a binder having a front cover, back cover, and a spine coupled to the front and back cover. More specifically, the front cover includes a substantially transparent window inset in the front cover. According to one exemplary embodiment, the window is substantially flush with the surface of the front cover. The front cover also includes an inner panel on back of the front cover to define a pocket. Visual display materials may be inserted into the pocket and be visible through the transparent window of the front cover.

According to one exemplary embodiment, the binder is composed of a front cover having a substantially transparent window integral with a first side of the front cover and an inner panel coupled to a second side of the front cover to form a pocket. The binder includes a rigid spine that is coupled to a back cover and the front cover. In one exemplary embodiment, a plurality of rings may be positioned on the spine. In another exemplary embodiment, the plurality of rings may be positioned on the back cover.

In another exemplary embodiment, the binder is composed of a front cover having an opening positioned thereon. An outer panel may be positioned within the opening, and an inner panel coupled to the second side of the front cover to define a pocket. The binder also includes a spine composed of a convex main body, a first flange coupled to the first hinge and a second flange coupled to the second hinge where the front cover is coupled to the first flange and the back cover is coupled to the second flange. In one exemplary embodiment, a plurality of rings may be positioned on the spine. In another exemplary embodiment, the plurality of rings may be positioned on the back cover.

In yet another exemplary embodiment, the binder is composed of a polypropylene front cover having a first side, a second side and an opening positioned thereon where a polycarbonate window is positioned within the opening of the front cover. The binder also includes a means for coupling an inner panel and the polycarbonate window to the second side of the front cover. Additionally, the binder includes a spine composed of a convex main body, a first flange coupled to the first hinge and a second flange coupled to the second hinge where the front cover is coupled to the first flange and the back cover is coupled to the second flange. In one exemplary embodiment, a plurality of rings may be positioned on the spine. In another exemplary embodiment, the plurality of rings may be positioned on the back cover.

### BRIEF DESCRIPTION OF THE DRAWINGS

FIG. 1 is a perspective view of an exemplary binder embodiment;

FIG. 2 is an end view of the exemplary binder embodiment of FIG. 1;

FIG. 3 is a top view of the exemplary binder embodiment of FIG. 1 in an open position;

FIG. 4 is an end view of the exemplary binder embodiment of FIG. 3;

FIG. 4A is an enlarged cross-sectional view of the exemplary binder embodiment of FIG. 3;

FIG. 5 is a top view of another exemplary binder embodiment shown in an open position;

FIG. 6 is a cross-sectional view of FIG. 5 taken along line 6-6;

FIG. 7 is an exploded view of the exemplary binder embodiment depicted in FIG. 5; and

FIG. 8 is an enlarged cross-sectional view of an edge of the exemplary binder as depicted in FIG. 6.

### DETAILED DESCRIPTION

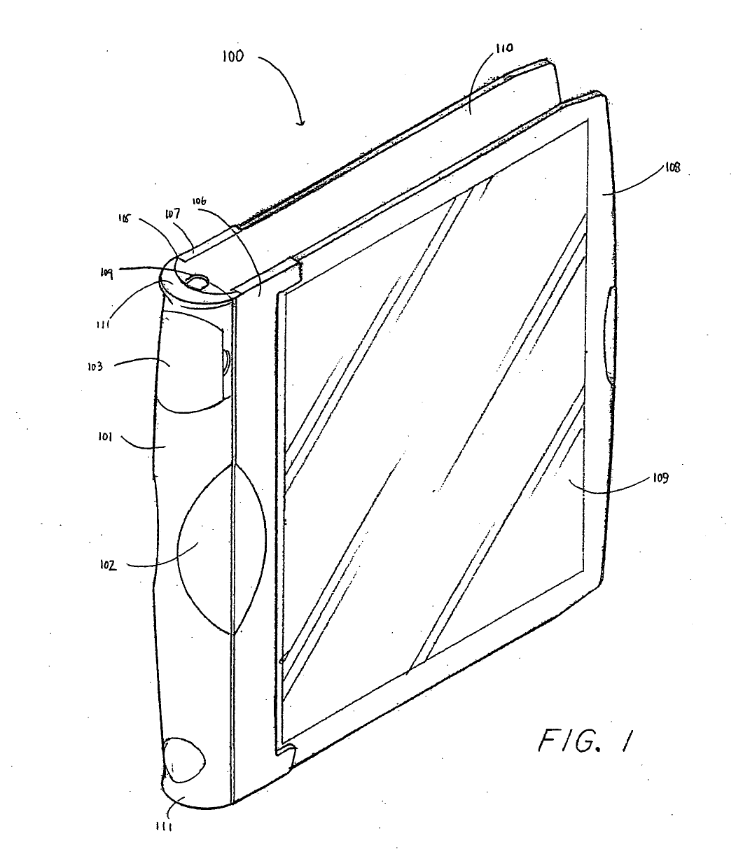

As shown in FIG. 1, an exemplary binder 100 is composed of a front cover 108 and a back cover 110 joined to a spine 101. The front cover 108 is a generally planar surface made from polypropylene having a substantially transparent window 109. As shown in FIG. 1, the window 109 is unitary with the front cover 108. More specifically, the window 109 is a polished portion of the front cover 108. Because the window 109 is unitary with the front cover 108, the front cover is substantially rigid structure. Furthermore, the perimeter surrounding the window 109 may be textured to create the appearance of a frame so as to improve the aesthetic appearance of the front cover 108.

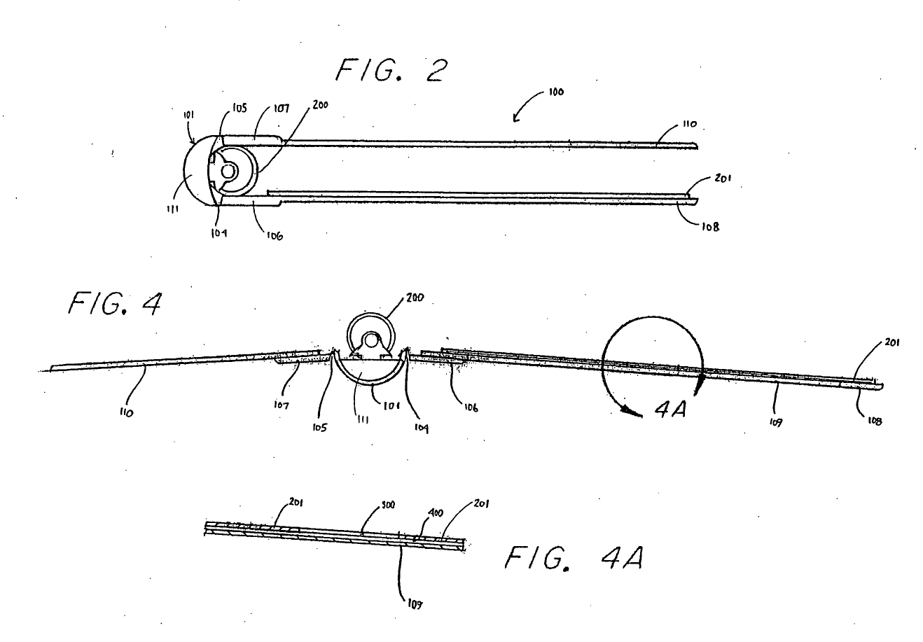

Continuing with FIG. 1, the binder includes a spine 101 that is composed of a main body coupled to a first flange 106 and a second flange 107 by a first hinge 104 and a second hinge 105, respectively. The front 108 and back cover 110 of the binder 100 are coupled to spine via the first 106 and second flanges 107. As shown in FIGS. 1, 2 and 4, the main body of the spine 101 has a generally convex shape. Also, footings 111 are provided at the ends of the main body of the spine 101. The footings 111 and the convex shape of the spine 101 provide added stability to the binder 100 when it is stood up on a surface. In an alternate embodiment, the spine 101 may be a generally planar structure where the front cover 108 and the back cover 110 are coupled to the spine via hinges 104, 105.

Turning to FIG. 4, the inner surface of the spine 101 is generally planar so that a ring assembly 200 may be coupled to the spine 101. In alternate embodiments, the ring assembly 200 may be coupled to the second flange 107 or the back cover 110. As shown in FIG. 1, a removable window 103 set within the spine body 101 so that labels or other identifying media may be placed between the removable window 103 and the spine body 101. According to one exemplary embodiment, the spine 101 may also include indentations 102 on the surface of the spine body 101 and the flanges 106, 107 that allow an individual to better grasp the spine 101 of the binder. In another exemplary embodiment, the indentations 102 may be provided on either the spine body 101 or the flanges 106, 107. As those skilled in the art will appreciate, other exemplary embodiments may not be provided with indentations on the spine.

The binder 100 also includes an inner panel 201 that is coupled to the front cover 108 to define a pocket 400 as shown in FIGS. 24. The inner panel 201 is bonded directly to the front cover 108 along the bottom and the two sides of the inner face of the front cover 108 of the binder 100. The upper edge of the inner panel 201 is not bonded to the front cover to permit the insertion of visual display material (not shown). Once inserted into the pocket 400, the visual display material is visible through the window 109 of the front cover 108.

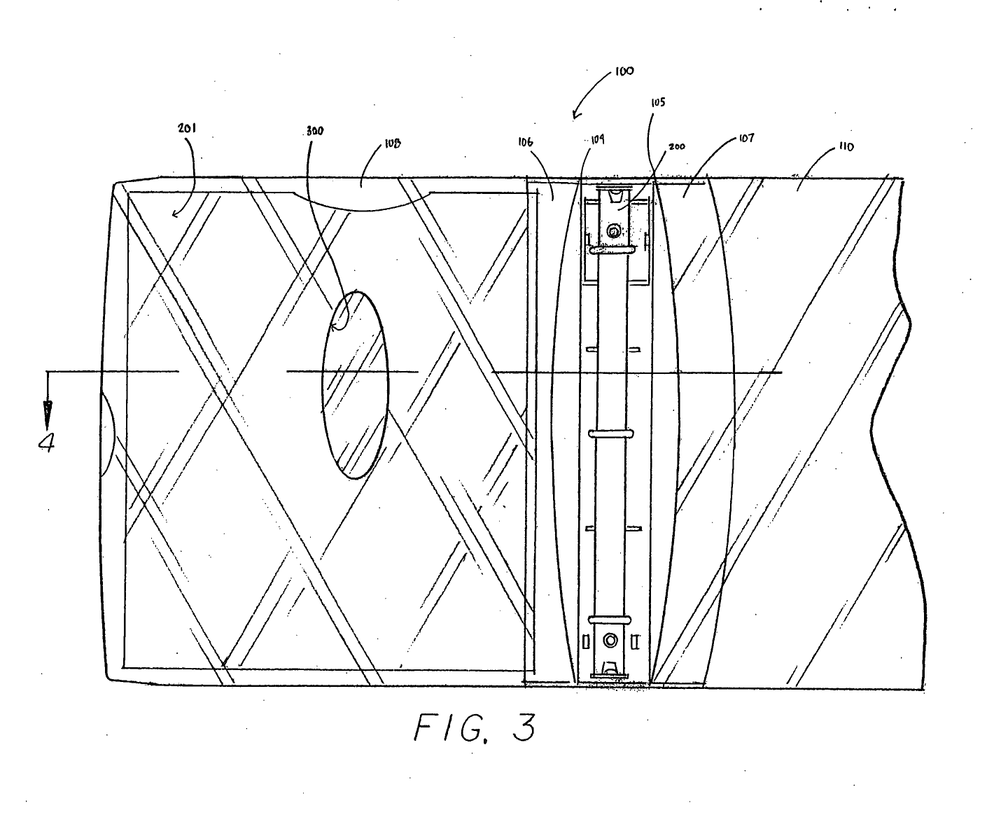

Additionally, as shown in FIG. 3, the inner panel 201 may include a notch 302 that also allows an end user to more easily access and remove the visual display material from the pocket 400. In alternate embodiments, as those skilled in the art will appreciate, the top of the inner panel 201 may not be provided with a notch. In yet another embodiment, the inner panel 201 may also include an opening 300 on the surface of the inner panel 201 that facilitates the insertion and removal of material from the pocket 400. That is, the end user can access the visual display material through the opening 300 and push the material toward the opening 301 of the pocket 400.

According to the exemplary embodiment depicted in FIGS. 1-4A, the components of the binder (i.e., the front cover 108, the back cover 110, and spine 101, and inner panel 201) may be made from a plurality of plastic materials such as, but not limited to, polypropylene, polycarbonate, or polystyrene. Depending on the material compatibility of the binder components, the front 108 and back cover 110 may be coupled to the first 106 and second flanges 107 of the spine 101 by welding means known or developed in the art. For instance, if the spine 101 and the front 108 and back cover 110 are made from similar materials such as polypropylene, these components may be coupled together by sonic welding and other heat welding means. Alternatively, if the materials cannot be bonded by heat welding means, as those skilled in the art will appreciate, the front 108 and back cover 110 may be coupled to the flanges 106, 107 by other means such as, but not limited to, adhesives and/or tacking with mechanical rivets.

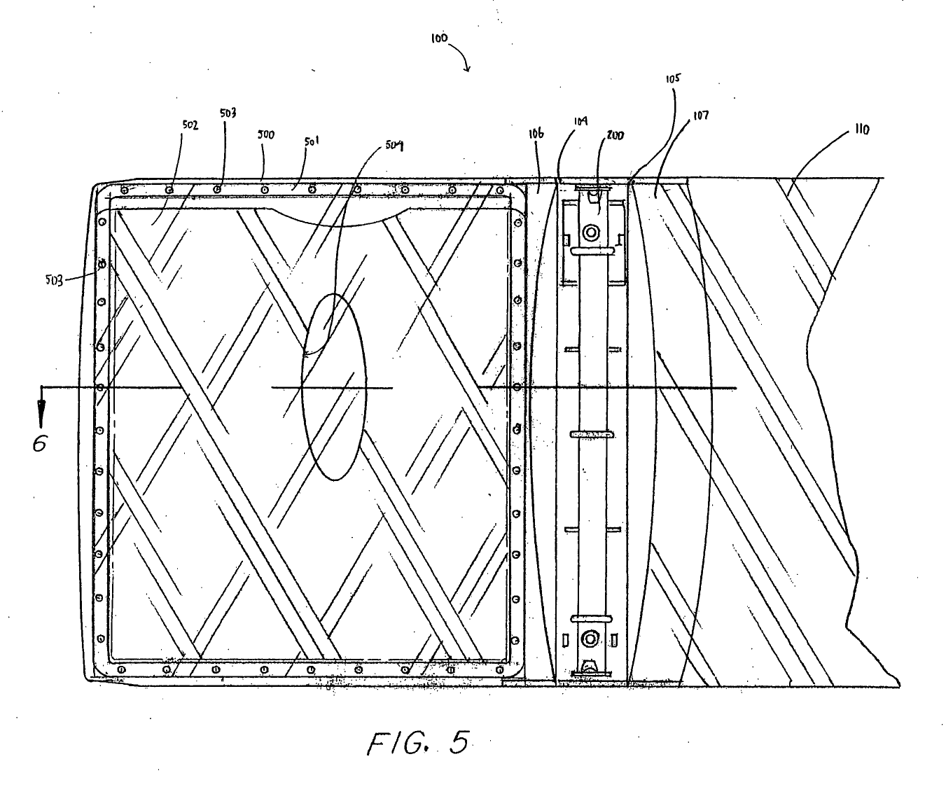

In another exemplary binder embodiment as illustrated in FIGS. 5-8, the binder is similar to the embodiment illustrated in FIGS. 1-6A except for the construction of the front cover and the window. The embodiments depicted in FIGS. 5-8 show a front cover 500 assembled from components with distinct material properties. For example, in the exemplary embodiment depicted in FIGS. 5-8, the front cover is composed of a substantially transparent polycarbonate window 501 that is integral with a polypropylene front cover 500 of the binder. More specifically, the front cover 500 forms a “frame” around an opening on the front cover 500. The window 501 may then be positioned over the opening to complete the front cover 500. According to one exemplary embodiment, the window 501 may be recessed with respect to the surface of the front cover 500. In another exemplary embodiment, as shown in FIG. 7, the window 501 includes a stepped edge around the perimeter of the window so that the surface of the window 501 is substantially flush with the surface of the front cover 500.

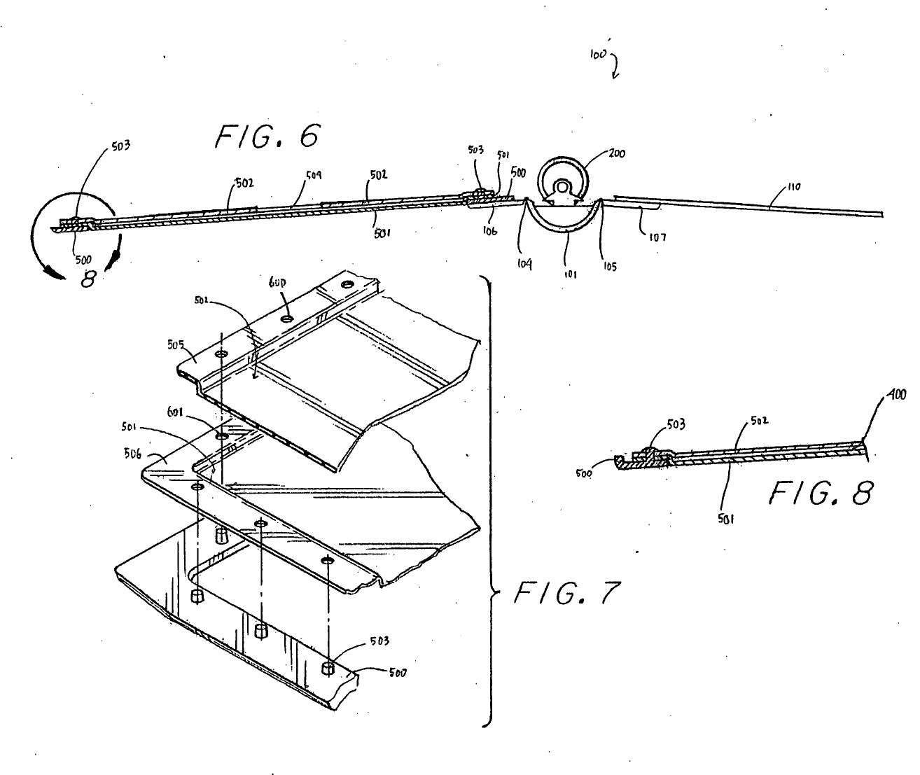

Turning to FIG. 5, an inner panel 502 is positioned over the window 501 to define a pocket 400 that is capable of holding visual materials that may be seen through the window 501. More specifically, the inner panel 502 is coupled along the sides and the bottom of the front cover 500 by plurality of rivets 603. As shown in FIGS. 6-7, the inner panel 502 may include a stepped edge 505. The stepped edge 505 allows the main surface of the inner panel 502 to be closer to the surface of the window 501 thereby ensuring that the visual media is securely positioned within the pocket 400. As those skilled in the art will appreciate, the height of the stepped edge 505 may be varied to accommodate visual materials having varying thickness. For instance, in alternate embodiment, the inner panel 502 may not include a stepped edge rather the inner panel would have a substantially planar surface.

Returning to FIG. 5, the inner panel 502 may be shorter than the window 501 so as to provide a gap that eases the insertion or removal of the visual display material. In alternate embodiments, the inner panel 502 may include a notch 505 that also allows an end user to more easily access and remove the visual display material from the pocket 400 as shown in FIG. 5. In alternate embodiments, as those skilled in the art will appreciate, the top of the inner panel 502 may not be provided with a notch. In yet another embodiment, the inner panel 502 may also include an opening 504 on the surface of the inner panel 502 that facilitates the insertion and removal of material from the pocket 400. That is, the end user can access the visual display material through the opening 504 and push the material toward the opening of the pocket 400.

As previously discussed, the front cover 500 of the binder 100 is composed of a polycarbonate window and a polypropylene front cover. Because the front cover and the window are made from incompatible materials, these components cannot be readily heat welded together. Accordingly, alternate methods of securing the window 501 to the front cover 500 have been developed. In one exemplary embodiment, the front cover includes a plurality of posts 503 that protrude from the surface of the front cover 500. Also, a plurality of openings 600, 601 are positioned along the perimeter of the window 501 and the inner panel 502 and are sized to engage the posts 503 as shown in FIG. 7. The posts 503 may then be heat staked to mechanically attach the window 501 and the inner panel 502 to the front cover to form an integral structure.

In another exemplary embodiment, the window 501 and the inner panel 502 may be coupled to the front cover by a snap-fit relation. For instance, as shown in FIG. 8, an enlarged knob is provided at the end of the post 503 wherein one side of the knob is mushroom-shaped. That is, the upper surface of the knob is curved and the lower surface of the knob has a substantially flat surface. As those skilled in the art will appreciate, the knob may be shaped as a pyramid, a cone, or other geometric shape so long as knob has a larger diameter than the corresponding openings 600, 601 on the inner panel 502 and the window 501. Accordingly, the inner panel and the window may be snapped over the post and secured to the front cover 500.

Additional objects and advantages of the exemplary binder embodiments will become readily apparent to those skilled in the art. The exemplary embodiments are shown and described, simply by way of illustration of the best mode contemplated of carrying out these exemplary embodiments. It is also contemplated that the exemplary embodiments are capable of modification in various respects, all without departing from the scope and spirit of the disclosed exemplary embodiments described herein. Accordingly, the drawings and description are illustrative and not intended to be a limitation thereof.

1. A binder comprising:
a front cover having a substantially transparent window inset into the front cover and an inner panel coupled to a second side of the front cover to form a pocket, wherein visual display materials are insertable into said pocket and visible through the front cover;
a back cover;
a spine interconnecting the front cover and the back cover; and
a plurality of rings positioned on the spine.

2. The binder of claim 1 wherein the substantially transparent window is substantially flush with the front cover.

3. The binder of claim 1 wherein the substantially transparent window is recessed with respect to the front cover.

4. The binder of claim 1 wherein the inner panel includes an opening.

5. The binder of claim 1 wherein the spine includes a first hinge and a second hinge.

6. The binder of claim 5 wherein the spine further comprises a convex main body, a first flange coupled to the first hinge and a second flange coupled to the second hinge.

7. The binder of claim 6 wherein the spine includes indentations on the convex main body of the spine.

8. The binder of claim I wherein the front cover, the back cover, the spine, and the inner panel are made of polypropylene.

9. A binder comprising:
a front cover having an opening positioned thereon;
an outer panel positioned within the opening, and an inner panel coupled to the second side of the front cover to define a pocket;
a back cover;
a spine comprising a convex main body, a first flange coupled to the first hinge and a second flange coupled to the second hinge, wherein the front cover is coupled to the first flange and the back cover is coupled to the second flange; and
a plurality of rings positioned within the main body of the spine.

10. The binder of claim 9 wherein the front cover, the back cover and the spine are made of polypropylene, and the outer panel and the inner panel are made of polycarbonate.

11. The binder of claim 9 wherein the inner panel includes a slot.

12. The binder of claim 9 wherein the outer panel is substantially flush with the front cover.

13. The binder of claim 9 further comprising a plurality of posts extending away from the second side of the front cover.

14. The binder of claim 13 further comprising a plurality of openings positioned along the perimeter of the inner panel and the outer panel, wherein the openings are sized to engage the plurality of posts positioned on the second side of the front cover.

15. The binder of claim 14 wherein the inner panel and the outer panel are heat staked to the front cover.

16. The binder of claim 14 wherein the inner panel and the outer panel are snap-fitted onto the front cover.

17. A binder comprising:
a front cover made from a first material having a first side, a second side and an opening positioned thereon;
a substantially transparent window made from a second material positioned within the opening of the front cover, wherein the first material and the second material are incompatible;
a means for coupling an inner panel and the substantially transparent window to the second side of the front cover;
a back cover made from the first material;
a spine comprising a convex main body, a first flange coupled to the first hinge and a second flange coupled to the second hinge, wherein the front cover is coupled to the first flange and the back cover is coupled to the second flange; and
a plurality of rings positioned within the main body of the spine.

18. The binder of claim 17 wherein the inner panel includes a slot positioned thereon.

19. The binder of claim 18 wherein the means for coupling the inner panel and the substantially transparent window to the front cover comprises a plurality of posts extending away from the second side of the front cover, and a plurality of openings positioned along the perimeter of the inner panel and the substantially transparent window, wherein the openings are sized to engage the plurality of posts positioned on the second side of the front cover.

20. The binder of claim 19 wherein the inner panel and the substantially transparent window are heat staked to the second side of the front cover.

21. The binder of claim 19 wherein the inner panel and the substantially transparent are snap-fitted onto the front cover.

22. The binder of claim 17 wherein the first material is polypropylene and the second material is polycarbonate.
